(19) United States
(12) Patent Application Publication
(10) Pub. No.: US 2008/0178088 A1
(43) Pub. Date: Jul. 24, 2008

(54) METHOD AND DEVICE OF CUSTOMIZING HEADPHONES

(75) Inventors: Steven W. GOLDSTEIN, Delray Beach, FL (US); John P. Keady, Boca Raton, FL (US)

Correspondence Address: GREENBERG TRAURIG, LLP, 2101 L Street, N.W., Suite 1000, Washington, DC, 20037, US

(73) Assignee: Personics Holdings Inc., Boca Raton, FL (US)

(21) Appl. No.: 11/829,676

(22) Filed: Jul. 27, 2007

Related U.S. Application Data
(60) Provisional application No. 60/820,590, filed on Jul. 27, 2006.

(51) Int. Cl. G06F 3/16

(52) U.S. Cl. 715/727

(57) ABSTRACT

At least one exemplary embodiment is related to a method of device customization comprising: entering physiological data, where the physiological data is obtained from a visual image loaded by a web based software program; selecting device features using the web based software program; and selecting the device appearance using the web based software program.

### CROSS-REFERENCE TO RELATED APPLICATIONS

This application claims the benefit of U.S. provisional patent application No. 60/820,590 filed on 27 Jul. 2006, incorporated by reference in it's entirety.

### FIELD OF THE INVENTION

The present invention relates to the customizing of a product via a remote user interactive system, and more particularly, though not extensively, relates to a web based user interactive method to enter physiological data and customize a headphone system.

### BACKGROUND OF THE INVENTION

The portable personal music player enjoys a level of popularity that is unprecedented in consumer electronics. This popularity can be attributed to many different factors: strong marketing, decreased costs, improved performance and capacity, etc. But perhaps the most fundamental aspect of the portable personal music player's appeal relates to the fact that such a device is inherently personal. The end-user personalizes their portable music player by filling it with their own audio content collection and their own playlists. An individual's audio content collection and an individual's personalized playlists constitute a substantial commitment of time and effort as well as a personal statement of interests. As such, the portable personal music player takes on a unique gestalt. It becomes more than a simple piece of consumer electronics. It becomes a statement of individuality and a vehicle for self-expression.

Today's personal music players are typically equipped with very low cost, low quality, disposable headphones that are often worn by the user for extended periods of time. Not only does this prolonged use produce physical ear fatigue, but also results in marginalized audio playback quality. The “one-size-fits-all” design approach presently adopted by many headphone manufactures minimizes critical personal design elements in order to accommodate the general public at large.

Of course, these “one-size-fits-all” headphone systems fail to address the individuality of the listener. The anthropometrical differences across listeners are ignored, resulting in poor ergonomics as well as compromised audio playback fidelity. Also, the psychoacoustic considerations unique to a headphone listening scenario as well as the psychoacoustic considerations unique to an individual listener are neglected by current headphone systems. Inherent in the “one-size-fits-all” approach, today's headphone systems are ergonomically and psychoacoustically mismatched, resulting in an overall performance mismatch.

By providing customizable headphone systems to consumers, the present invention attempts to utilize some of the same personalization appeal that drives the popularity of the portable personal music player. The function, fit, and form of the custom headphone systems may be entirely personalized by the individual. Much like the portable music player loaded with the individual's personal music collection, the custom headphone system additionally becomes a statement of individuality and a vehicle for self-expression.

The aesthetics of current headphone systems are generally fixed during the manufacturing process. In addition to personalization, modern consumers have a growing penchant for designer merchandise and merchandise associated with icons. This trend is illustrated by the success of footwear bearing the name of professional basketball players, or by the popularity of eyewear associated with fashion designers. Additionally, as the popularity of the portable personal music player grows, so does the demand for quality headphone systems. Similarly, as portable personal music players become more compact, consumers demand headphone systems with smaller form factors and comparable sound quality. These trends have led to the rise in popularity of intra-aural, or “in-the-ear,” headphone systems. These types of headphone systems are often referred to as “earphones” or “earbuds” and have quickly become the most common type of consumer headphone system. Intra-aural headphone designs tend to be more compact and less expensive than their circum-aural or supra-aural counterparts.

Let us further subdivide the category of intra-aural headphone systems into two groups. One group consists of intra-aural headphone systems that completely close the listener's ear canal, possibly extending into the listener's ear canal. This group will be referred to as “closed intra-aural headphones” and consists of hearing aids, custom-molded headphone systems, and some consumer headphone systems. The second group consists of intra-aural headphone systems that do not completely close the listener's ear canal or “open intra-aural headphones.” These headphone systems are positioned very close to the ear canal entrance, resting on the concha or wedged in between the tragus and antitragus of the listener's ear. A common example of the open intra-aural headphones type is the white earbuds distributed with the popular Apple iPod personal music player.

Currently, there are several significant problems inherent to both types of intra-aural headphone designs. The most obvious problem stems from the fact the external ear of each individual is unique. As suggested above, for some closed intra-aural designs, this problem is addressed by building earpieces from custom molds of the listener's ears. However, the process of obtaining custom ear molds maybe too expensive and too time consuming for many consumers making it commercially unreasonable. As an alternative, some off-the-shelf closed intra-aural headphone systems include soft silicon attachments in a variety of sizes. The listener is to select the attachments that best fit the anthropometrics of his or her ear. Unfortunately, only a finite variety of attachments can be made available and not every listener's ears can be fit perfectly. An imperfect fit means the headphone system is not truly closed, resulting in inconsistent listening experiences, poor acoustic isolation, and even listener discomfort and premature listening fatigue.

It should also be noted that closed intra-aural headphone systems could cause excessive physical fatigue in the listener's ear if the ear tip protrudes too far into the listener's ear canal. Open intra-aural designs suffer even more from the inconsistencies between listeners' ears. Because open intra-aural headphone systems are generally designed with a “one-size-fits-all” philosophy, anthropometrical differences between listeners introduce several unknowns into the listening experience equation. For example, the proximity of the acoustic transducers to the listener's ear canal can only be approximated for an open intra-aural system. Therefore the maximum sound pressure levels (SPL) delivered to a listener's ear canal vary from listener to listener. More importantly, the exact orientation of the acoustic transducers with respect to the listener's ear canal is unknown. Earbuds wedged tightly in between the tragus and antitragus tends to form an obtuse angle with the listener's ear canal instead of the intended perpendicular relationship. This results in early acoustic reflections off the concha and other parts of the listener's anatomy that alter the frequency spectra of the audio playback.

The “one-size-fits-all” philosophy common to many intra-aural headphone designs also compromises listener comfort. This is especially true for open intra-aural designs, which may not comfortably fit individuals with smaller external ear anthropometrics as found within the female gender. Listener comfort may also be compromised for poorly fit closed intra-aural designs. Such ergonomic failures cause premature listener ear fatigue.

Another major problem inherent to intra-aural headphone designs or any other headphone design lies in the fact that headphone systems effectively bypass the pinna and other external elements of the listener's anatomy which are relevant to audition. This results in psychoacoustically mismatched audio content playback.

Acoustically, the pinna functions as a linear filter whose transfer function depends on the direction and distance of a sound source. Through this filtering of incident sound signals, linearly and differently depending on their direction and distance, the pinna encodes the spatial attributes of a sound field into temporal and spectral cues. This makes the pinna very important to spatial hearing (Jens Blauert, Spatial Hearing, 1974).

Because the pinna is effectively bypassed by headphone systems, headphones generally do not deliver a spatially convincing listening experience. Instead, headphones deliver a listening experience with sound sources that seem to originate from inside the listener's head. Headphone listeners typically accept this type of psychoacoustically mismatched audio content, but this need not be the case.

This problem has been addressed by applying head-related transfer functions (HRTF) to audio playback over headphones. HRTF data describes the spatially dependent filter characteristics of the pinna and the other external elements of a listener's anatomy relevant to audition (i.e. the acoustic shadowing of a listener's head). Processing headphone playback with the appropriate HRTF data can result in a perceptually convincing, spatially rich sound field, significantly enhancing the listening experience. However, HRTF data is unique to each individual, and one set of HRTF data will not be perceptually convincing for every listener (Rumani Duraiswami, 2006).

### SUMMARY OF THE INVENTION

At least one exemplary embodiment is directed to a method of device customization comprising: entering physiological data, where the physiological data is obtained from a visual image loaded by a web based software program; selecting device features using the web based software program; and selecting the device appearance using the web based software program.

A method of device customization comprising: checking a user's member registration; entering stored physiological data from a database if a user's membership has been verified; selecting device features using the web based software program; and selecting the device appearance using the web based software program.

Further areas of applicability of exemplary embodiments of the present invention will become apparent from the detailed description provided hereinafter. It should be understood that the detailed description and specific examples, while indicating exemplary embodiments of the invention, are intended for purposes of illustration only and are not intended to limited the scope of the invention.

### BRIEF DESCRIPTION OF THE DRAWINGS

Exemplary embodiments of present invention will become more fully understood from the detailed description and the accompanying drawings, wherein:

FIG. 1 is an illustration of an example of a user interactive system that can be used to implement at least one exemplary embodiment;

FIG. 2 is a block diagram of elements associated with a method in accordance with at least one exemplary embodiment;

FIG. 3 illustrates a method of entering physiological data in accordance with at least one exemplary embodiment;

FIG. 4 illustrates the alignment of an anatomical feature in GUI of a software system in accordance with at least one exemplary embodiment;

FIG. 5 illustrates an example of entering a snapshot of anatomical features with a dimension indicator according to at least one exemplary embodiment;

FIG. 6 illustrates an example of an entered snapshot of an ear in accordance with at least one exemplary embodiment;

FIG. 7 illustrates a series of steps in a customization process in accordance with at least one exemplary embodiment; and

FIG. 8 illustrates a GUI interface of a software program that displays a customized product in accordance with at least one exemplary embodiment.

### DETAILED DESCRIPTION OF EXEMPLARY EMBODIMENTS OF THE PRESENT INVENTION

The following description of exemplary embodiment(s) is merely illustrative in nature and is in no way intended to limit the invention, its application, or uses.

Exemplary embodiments can be applied to various products, including other products where physiological properties (e.g., dimensions, color, hair type, body proportions, and other physical characteristics as known by one of ordinary skill in the relevant arts) can be captured by a device attached to a computer or other electronic device.

Processes, techniques, apparatus, and materials as known by one of ordinary skill in the art may not be discussed in detail but are intended to be part of the enabling description where appropriate. For example specific computer code may not be listed for achieving each of the steps discussed, however one of ordinary skill would be able, without undo experimentation, to write such code given the enabling disclosure herein. Such code is intended to fall within the scope of at least one exemplary embodiment.

Additionally exemplary embodiments are not limited to psychoacoustical apparatus (e.g. earpieces, headphones), for example, the system can be designed for use with footwear using visual methods of physiological data gathering. Additionally, exemplary embodiments can be used with non-digital systems as well as digital systems (e.g., photographic systems using CCDs), for example a film image pickup apparatus can be used to obtain an image and then a scanning system can digitize the film image. The digitized film image can then be subject to the procedures discussed herein in accordance with at least one exemplary embodiment.

Notice that similar reference numerals and letters refer to similar items in the following figures, and thus once an item is defined in one figure, it may not be discussed or further defined in the following figures.

### SUMMARY OF EXEMPLARY EMBODIMENTS

At least one exemplary embodiment of the present invention is directed to a system for the application of HRTF data to audio playback over headphones as well as a variety of methods for collecting personalized or semi-personalized HRTF data for individual listeners. In one embodiment, the end-user is able to select from a variety of semi-personalized HRTF data by entering different codes through an interface.

Just as the aesthetic taste of an individual is unique, so is the hearing of the individual. Another psychoacoustic consideration related to the customization of headphone systems accounts for the differences in how well individuals can hear at different frequencies. An audiogram process provides a description of an individual's ability to perceive sounds at different frequencies and can be loaded onto a member's online file (stored in a database) and can be retrieved later as physiological data to customize headphones, earpieces or other products.

By allowing consumers to customize headphone systems by selecting a series of interconnecting parts in a variety of colors, designs, and styles, the present invention provides the consumer with an element of self-expression through aesthetics, which is absent in current headphone systems. Furthermore, an engraving process allows the end-user to specify a name or set of characters to be indelibly stamped on the custom headphone systems, adding to the personalization appeal as well as improved security.

The present invention encourages designers and other icons to participate in co-branding, lending their sense of asthetic expression and name to custom headphone designs. This approach brings headphone systems into the realm of designer merchandise, allowing the end-user to make even bolder statements of individuality and self-expression. Customized headphones systems also allow the listener to select ear tip styles that are comfortable for their ear anthropometrics.

At least one exemplary embodiment of the present invention purposes that customized headphone systems are more accurately positioned with respect to an individual's ear canal, allowing for more accurate real-ear level SPL measures and improved audio playback fidelity.

At least one exemplary embodiment of the present invention is directed to a set of improved fitting processes intended to enhance listener comfort as well as audio playback performance. These fitting processes include anthropometrical measurements of the external ear and even the entire head.

At least one exemplary embodiment of the present invention are methods for the acquisition of a listener's relative audiogram as well as methods for applying audiogram compensation filters to audio playback. This matching process personalizes the listening experience for the individual's psychoacoustics. Relative audiogram tests can be carried out through a registration process related to embodiments of the present invention. Alternatively, the custom headphones are capable of recording relative audiogram data about a listener without an outside registration process.

Because hearing loss, playback preferences, aesthetic appeal, and other aspects relating to custom headphone systems tend to correspond demographic boundaries, specific custom headphone designs will be developed for specific demographic groups. Different default settings can be set for different age groups, different genders, and different geographic regions. For example, custom headphone systems with an enhanced low-frequency response and a certain “hip-hop” aesthetic can be intended for the urban youth demographic.

Currently, most headphone systems use only two acoustic transducers—one for each ear. However, some high-end headphone systems employ additional acoustic transducers and a frequency crossover circuit to improve the headphone system's frequency response. Audio professionals will select combinations of acoustic transducers to create a variety of custom headphone transducer arrangements, providing the customer with a variety of default arrangements to choose from. The customer can also select the combination of acoustic transducers and crossover configurations directly.

Furthermore, at least one exemplary embodiment of the present invention provides a combination of optional features not commonly available in current headphone systems. Such features include wireless operation, inter-system audio signal sharing, text-to-speech conversion, active noise cancellation, end-user equalization, and a clock. These optional features provide yet other layers of personalization to the custom headphone systems.

Consumer electronics with a small form factor and a moderately high price point are a common target for thieves. Personal music players and custom headphone systems fall into this category. Therefore, the present invention includes a communications port, allowing the entire headphone system to be disabled remotely over a communications network. This acts as a deterrent for thieves and possibly even a stolen-merchandise recovery mechanism.

Consider that reading glasses available at the drugstore are truly useful for only a few individuals. Many individuals require the services of an optometrist and personalized eyewear. Similarly, the present “all-size-fits-one” headphone systems are appropriate for a small cross-section of the population. The majority of individuals who are outside this segment of the population would benefit from customized headphones and the related services.

Actually, exemplary embodiments of the present invention have many parallels to the optometrist's eyewear distribution model. The customer first selects a headphones style; similar to the eyewear frames selection process. The customer is then tested for sensory acuity (visual or auditory). The results of these tests are then used to customize the end product (eyeglasses or headphones). Also, both eyeglasses and custom headphones can help compensate for an individual's lack of sensory acuity. The difference in exemplary embodiments of the present invention is that physiological data is obtained and stored via an electronic device and retrieved, for example in the form of a image to obtain the design features to customize a device.

The distribution model for customized headphone systems takes two forms: a traditional retailing model and an e-tailing model. In the retailing model, custom headphone systems are sold to consumers at a store with a physical location (i.e. the shopping mall). Again, consider the analogy to the optometrist's eyewear store. The custom headphones retail store might look quiet similar. The customer is able to browse a selection of headphone styles, designs, parts, and form factors. The customer is then fit anthropometrically as well as psychoacoustically (i.e. HRTF, audiogram). Custom headphone systems are then personalized and assembled into a finished product while the customer waits.

In the e-tailing model, custom headphones are sold to the consumer through an online store. A website interface allows the customer to browse a selection of headphone styles, designs, parts, and form factors. Through a registration process, the customer supplies all the information necessary for creating custom headphone systems. Digital photographs of the customer's ears along with some standard reference object provide anthropometrical data for fitting the customer, while an interactive testing system collects the required psychoacoustic data. Custom headphones are then personalized, assembled, and shipped to the customer.

### EXAMPLES OF EXEMPLARY EMBODIMENTS

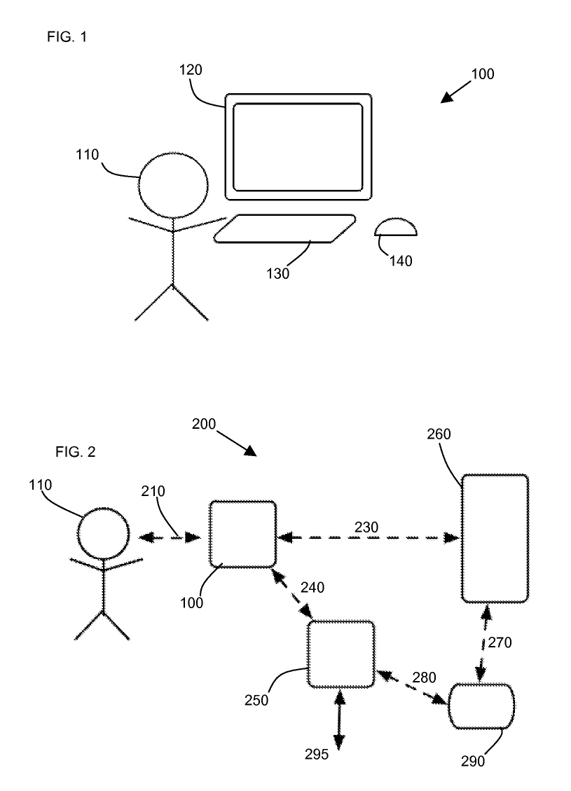

FIG. 1 is an illustration of an example of a user interactive system 100 that can be used to implement at least one exemplary embodiment. A user 110 can interface 130 (e.g., keyboard) and 140 (e.g., mouse) with a computer 120 (e.g., Macintosh, PC), to enter data for customizing a product.

FIG. 2 is a block diagram of elements associated with a method in accordance with at least one exemplary embodiment. A user 110 interfaces 210 with a software program (either locally or web based) on an interactive system 100. The user can enter membership information (e.g., ID number) or start registering, where the registration query or new information is sent 230 (e.g., via cable or wireless) to a database 260 (local or remote). The registration data can be retrieved later for verification of registration, and upon verification retrieve any useful data needed for customization (e.g., preferences, physiological data). Additionally an order signal can be sent 240 to an order monitoring system 240, to start the customization process. The ordering monitoring system 240 can send a check registration request 280 to a check registration function 290, which will check the database 270 for member information. If the membership information is verified an order notification signal is sent 295 to start the GUI interactive process for customization.

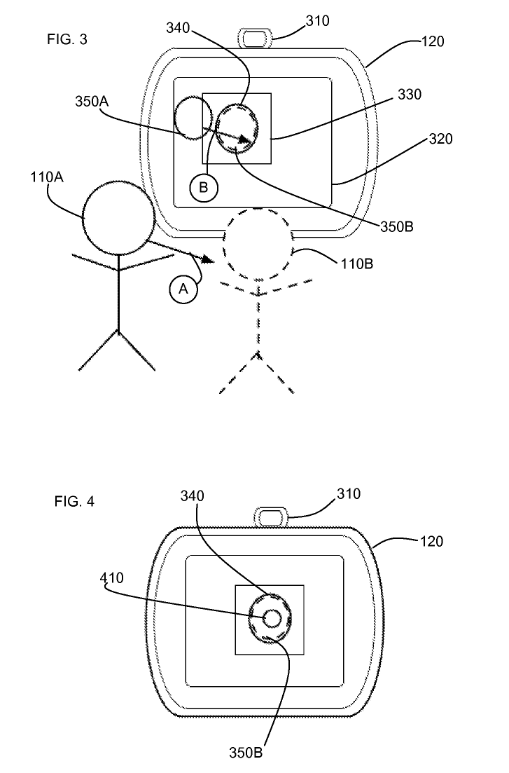

FIG. 3 illustrates a method of entering physiological data in accordance with at least one exemplary embodiment. One of the first steps is to enter physiological data if it hasn't already been entered via a previous registration. FIG. 3 illustrates a computer 120 with a camera 310 that a user 110A uses to attempt to fit a picture of an anatomical feature (e.g., head, ear, foot) into a centering frame 340, within an alignment frame 330 in a GUI software system 320. As illustrated the user 110A moves (A) to a position 110B and as he/she does so the camera view of their face 350A moves (B) to a position 350B within the centering frame 340. When centered the user presses a take button to take and store the image. This process can be repeated for various views (e.g., close-ups). In addition to the anatomical feature a dimensional indicator 410 can be entered to provide scale to the captured images.

FIG. 4 illustrates the alignment of an anatomical feature in GUI of a software system in accordance with at least one exemplary embodiment. In this illustration the dimensional indicator 410 is embedded in the captured image (e.g., coin on nose or held next to ear for scale). In at least one exemplary embodiment a user can select which dimensioning feature they wish to use, and a dimensional oval appears for the user to move the head until the coin fits in the oval or a user can highlight (point an drag an encompassing oval) the dimensional indicator in an uploaded figure.

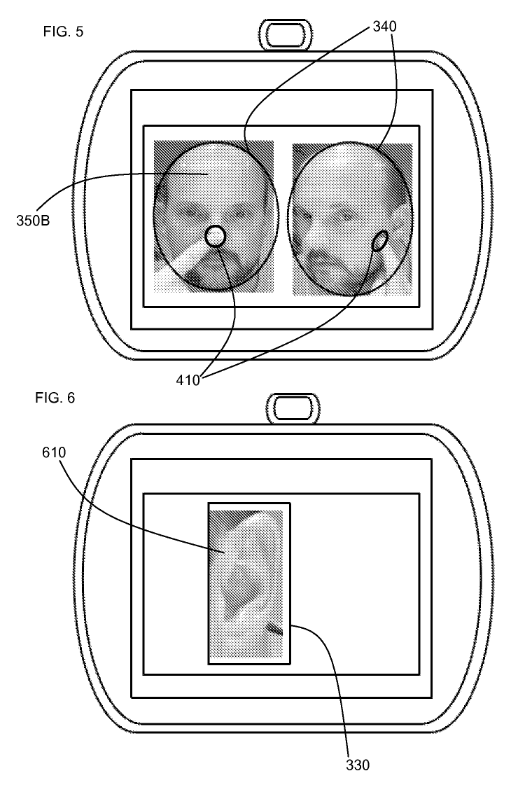

FIG. 5 illustrates an example of entering a snapshot of anatomical features 350B with dimension indicators (e.g., 410) according to at least one exemplary embodiment. In this non-limiting example a face is fit into the centering frames 340. In the left frame a front view image is supplied (uploaded or camera taken) and the right frame includes a skew view where the right ear just disappears from view

FIG. 6 illustrates an example of an entered snapshot of an ear in accordance with at least one exemplary embodiment. In addition to the face and head an image of an ear 610 can be placed within a centering frame 330. The pixels of the image can be analyzed by known methods to obtain edges and dimensions determined (e.g., using the dimensional indicator) to develop the general dimensions of any device displayed to the user.

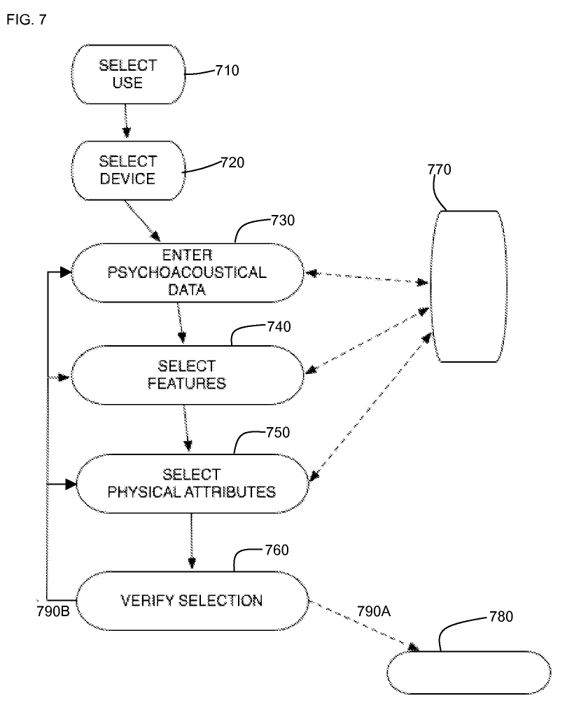

FIG. 7 illustrates a series of steps in a customization process in accordance with at least one exemplary embodiment. In at least one exemplary embodiment the user can customize a product (e.g., earpieces) using an interactive software system via a GUI interface. The user can select the use of the device, which can be broken into several categories for example environmental use and functional use. For example the user can specify environmental use (e.g., certain occupations can have minimal NRR standards, which the displayed device can illustrate various type of tips, sealing elements that provide the NRR level, and which a user can then select via a GUI system as described herein) of the product 710 (e.g., military, first responder, construction worker). Additional examples of environmental use include the particular country, state or region, in which the device is to be used (where for example NOSHI standards are downloaded to the device, and the device is modified to comply). Additionally a user can specify a functional use, for example a user is going to be in a noisy environment (environmental use) but intends to use it to listen to music (a functional use). Other non-limiting examples of functional use are, hours that intend to be used per day, cell phone use, game usage, and other use that one of ordinary skill would know. The Software then selects the various devices satisfying the selection of such an environment, and displays them (e.g., The user selects the one device he/she wishes to customize 720. The user then enters physiological data 730 (e.g., age, gender, audiogram, images of the ear as described above) which is sent or retrieved from a database 770. For example the audiogram can be obtained via a person's doctor, phone audiograms, or a headphone audiogram via a remote computer. The physiological data can be used to modify the device to optimize the fit and function of the device for the user (e.g., a frequency response modification function that takes into account a user's loss of hearing in one ear). The user can then enter the device features 740 (e.g., Sonic signature, sports package, SPL dosage, Bluetooth), the data of which is entered into a database or preferences retrieved as first default values that can be changed by the user. The user can then enter physical attributes of the elements of the device (e.g., color of certain elements) 750. For example the device can be displayed with certain elements (e.g., chasis 870, insert, tip, interface) to which a user can select color to apply to these elements. The user can then verify the configuration by verifying (e.g., pressing or clicking on a verify button 860).

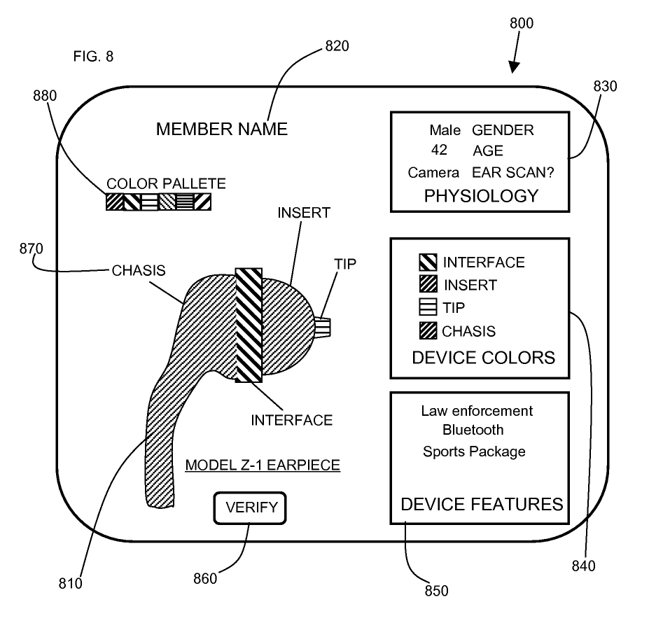

FIG. 8 illustrates a GUI interface 800, displaying a members name 820, of a software program that displays a customized product 810 in accordance with at least one exemplary embodiment. The various elements (chasis, insert, tip, interface) are retrieved from a database as modifiable elements that can be changed. For example a user can move a cursor to a color palette 880 and select a color and either drag to the element in question or click to select and then click on the desired element. Additionally the GUI interface 800 can display various other characteristics for example the physiology 830, the device colors 840, and the device features 850. If the user wishes to change any of the information (e.g., physiology) then the user can click on the title of the characteristic (e.g., Device Color) and a new window will open (e.g., in the case of physiology and device features) but not in some features (e.g., device colors, where device colors are easily changed by going to the color palette). When the user is satisfied with the customization he/she can select the verify button 860, which send an order signal to the ordering and billing software which will take payment and shipping information, then if payment is successful, then shipping will receive a notice to institute package and shipment.

In at least one further exemplary embodiment the user can select to see how the verified device looks in his/her uploaded image prior to purchase, and is given the opportunity to change parameters (device color, device functionality).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions of the relevant exemplary embodiments

Thus, the description of the invention is merely exemplary in nature and, thus, variations that do not depart from the gist of the invention are intended to be within the scope of the exemplary embodiments of the present invention. Such variations are not to be regarded as a departure from the spirit and scope of the present invention.

What is claimed is:

1. A method of device customization comprising:
entering physiological data, where the physiological data is obtained from a visual image loaded by a web based software program and used to modify or select a device;
selecting device features using the web based software program; and
selecting the device appearance using the web based software program.

2. The method according to claim 1, where the visual image is obtained by uploading images.

3. The method according to claim 1, where a user aligns orientations of physiological features into selected frames in a GUI of the software program, and selects an image capture function when aligned, where the images are processed by a logic circuit stripping out physiological features.

4. The method according to claim 3, where a dimensional indicator is included in the images.

5. The method according to claim 4, where the dimensional indicator is a chosen coin.

6. The method according to claim 5, where the image includes an image of a user's ear.

7. The method according to claim 1, where the step of selecting the device features includes:
entering the environmental use for the device.

8. The method according to claim 7, where the step of selecting the device features includes:
entering the functional use of the device.

9. The method according to claim 1, where the step of selecting the device appearance includes:
selecting a color for at least one element of the device.

10. The method according to claim 9, where the step of selecting a color include moving a cursor to a color palette, clicking a button to select a color from the color palette, moving the cursor to the element to color and selecting the element.

11. A method of device customization comprising:
entering stored physiological data from a database if a user's membership has been verified;
using the physiological data to select or modify a device;
selecting at least one device feature using a web based software program; and
selecting the device appearance using the web based software program.

12. The method according to claim 11, where the visual image is obtained by uploading images.

13. The method according to claim 11, where a user aligns orientations of physiological features into selected frames in a GUI of the software program, and selects an image capture function when aligned, where the images are processed by a logic circuit stripping out physiological features.

14. The method according to claim 13, where a dimensional indicator is included in the images.

15. The method according to claim 14, where the dimensional indicator is a chosen coin.

16. The method according to claim 15, where the image includes an image of a user's ear.

17. The method according to claim 11, where the step of selecting the device features includes:
entering the environmental use for the device.

18. The method according to claim 17, where the step of selecting the device features includes:
entering the functional use of the device.

19. The method according to claim 11, where the step of selecting the device appearance includes:
selecting a color for at least one element of the device.

20. The method according to claim 19, where the step of selecting a color include moving a cursor to a color palette, clicking a button to select a color from the color palette, moving the cursor to the element to color and selecting the element.
